(19) United States
(12) Patent Application Publication
(10) Pub. No.: US 2025/0388152 A1
(43) Pub. Date: Dec. 25, 2025

(54) FASTENER FOR NON-FOAM CUSHION

(71) Applicant: Lear Corporation, Southfield, MI (US)

(72) Inventors: David HALE, Northville, MI (US); Christopher D. JOHNSON, Novi, MI (US); Joshua HALLOCK, Warren, MI (US)

(21) Appl. No.: 18/750,517

(22) Filed: Jun. 21, 2024

(51) Int. Cl. B60N 2/75

(52) U.S. Cl. CPC B60N 2/75

(57) ABSTRACT

Fasteners to couple foamless cushions of intertwined or entangled polymeric filaments to non-cushion components and methods thereof. In a first embodiment, a fastener comprises a retainer portion that anchors the fastener in a mesh member cushion comprised of a plurality of bound or bonded polymeric filaments and a protruding portion that extends through the polymeric filaments of the cushion to another fastener. The retainer portion may have a larger dimension, area, or cross-section area than the retainer portion such that it is inhibited from penetrating through the polymeric filaments.

### TECHNICAL FIELD

The instant disclosure relates to cushion assemblies, fasteners for securing cushions, and methods of fastening cushions. More specifically, fasteners for fastening foamless filament nonwoven mesh structures.

### BRIEF DESCRIPTION OF THE DRAWINGS

FIG. 1 is a perspective view of an example of a seat assembly.

FIG. 2 is a partial cross-sectional view of a first embodiment of a fastener fastening a foamless filament nonwoven mesh structure to a surface.

FIG. 3 is a schematic partial cross-sectional view of an example of a manufacturing system for making a filament mesh structure.

FIG. 4 is a front perspective view of a second embodiment of a fastener.

FIG. 5 is a front perspective view of a cushion and a fastener to be disposed therein.

FIG. 6 is a front perspective view of the fastener of FIG. 5 disposed in the cushion of FIG. 5.

FIG. 7 is a front perspective view of a surface to be fastened to the cushion of FIGS. 5 and 6.

FIG. 8 is a front perspective view of the surface of FIG. 7 fastened to the cushion of FIGS. 5-7.

FIG. 9 is a top perspective view of a first embodiment of a non-cushion seat component (e.g., armrest) having two fasteners fastened thereto.

FIG. 10 is a schematic cross-sectional side view of the first embodiment of the non-cushion seat component of FIG. 9 with a cushion fastened thereto.

FIG. 11 is a side view of a second embodiment of a non-cushion seat component with a cushion fastened thereto.

FIG. 12 is flow chart of a method of making a seat assembly.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word about in describing the broadest scope of the invention. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose in connection with the invention implies the mixtures of any two or more of the members of the group or class are equally suitable or preferred. Molecular weights provided for any polymers refers to number average molecular weight. Description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially,” “generally,” or “about” may be used herein to describe disclosed or claimed embodiments. The terms “substantially,” “generally,” or “about” may modify a value or relative characteristic disclosed or claimed in the present disclosure to signify within manufacturing tolerances and/or within ± 0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

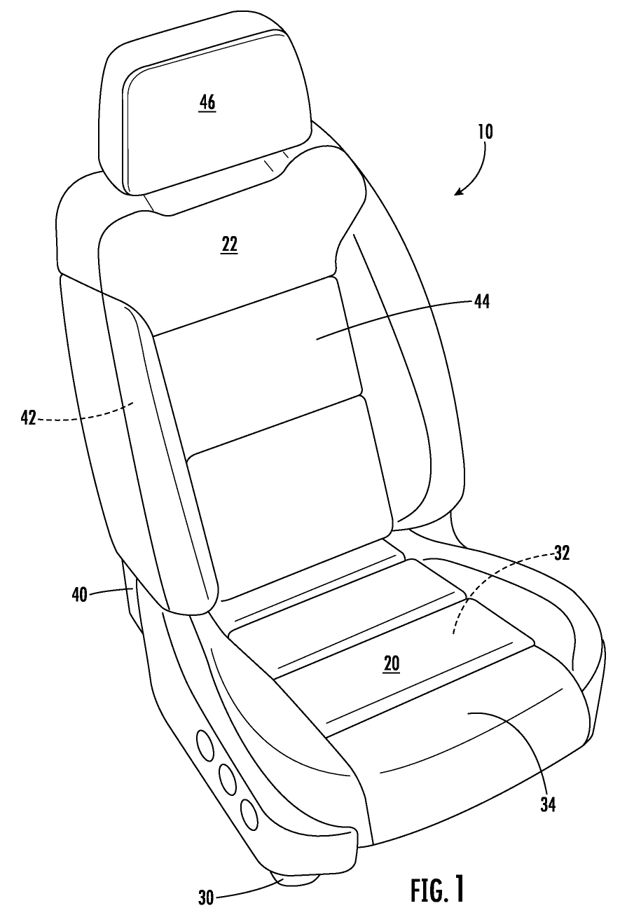

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool. In one or more embodiments, the seat bottom 20 is configured to receive a seated occupant and support the pelvis and thighs of the seat occupant. In various embodiments, the seat bottom 20 includes a seat bottom frame 30, a cushion 32, and a trim cover 34. In numerous embodiments, the seat bottom frame 30 is a structure that supports the cushion 32. In a variation, the seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed. In one or more embodiments, the cushion 32 is disposed on the seat bottom frame 30. In various embodiments, the cushion 32 is made of a compliant material that supports the seat occupant and distributes load forces from the seat occupant to the seat bottom frame 30.

In various embodiments, the trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. In one or more embodiments, the trim cover 34 is made of any suitable material or materials, such as fabric, leather, leatherette, vinyl, or combinations thereof. In a variation, the trim cover 34 may include a plurality of trim panels that are assembled in any suitable manner, such as by fusing or stitching. In a refinement, the trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad.

In one or more embodiments, the seat back 22 is configured to support the back of a seated occupant. In various embodiments, the seat back 22 is disposed adjacent to the seat bottom 20. For example, the seat back 22 may be disposed above the seat bottom 20 and near the rear side of the seat bottom 20. In a variation, the seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second-row seat assemblies. In one or more embodiments, the seat back 22 includes a seat back frame 40, a cushion 42, a trim cover 44, and optionally a head restraint 46.

In various embodiments, the seat back frame 40 is a structure that supports the cushion 42. In one or more embodiments, the seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

In one or more embodiments, the cushion 42 is disposed on the seat back frame 40. In various embodiments, the cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20.

In one or more embodiments, the trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. In various embodiments, the trim cover 44 is made of any suitable material or materials, such as fabric, leather, leatherette, vinyl, or combinations thereof. In a variation, the trim cover 44 may include one trim panel or a plurality of trim panels that are assembled in any suitable manner, such as by fusing or stitching. In a refinement, the trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

In a refinement, the frame 30 and/or 40 supports other components such as a massaging assembly, a ventilation assembly, a temperature control assembly, a sensor assembly, and/or an electronic assembly. In various embodiments, the seat frame(s) 30 and/or 40 are made of a rigid material (e.g., metal, plastic, wood, or a combination thereof) sufficient to support a seated occupant, one or more components/subassemblies. For example, a steel and/or aluminum seat frame 30, 40 is used.

In various embodiments, the head restraint 46, if provided, is configured to support the head of a seat occupant. In one or more embodiments, the head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

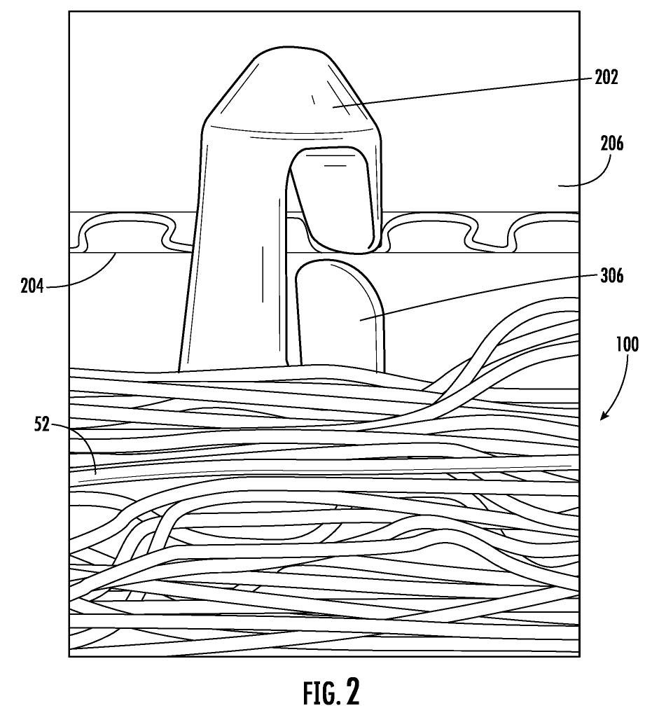

Referring to FIG. 2, an example of a cushion 100 is shown. It is to be understood that the structure and description of the cushion 100 may be applicable to the cushion 32 of the seat bottom 20, the cushion 42 of the seat back 22, and/or any other cushion described herein. In various embodiments, unlike conventional cushions which are generally molded foams, one or more of the cushions are foamless or comprised of a non-foam material such as a plurality of entangled and/or intertwined polymeric filaments 52 defining one or more cushion bodies as depicted in FIGS. 2 and 11. In other words, portions of the various polymeric filaments are entangled or otherwise bound with portions of other polymeric filaments such that the plurality of polymeric filaments serves as a single unit, piece, cushion, pillow, pad, or mat.

In one or more embodiments, the cushion 100 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In a variation, the cushion 100 is depicted as a non-foam component that does not include a foam component or foam material, such as urethane or polyurethane foam. However, it is contemplated that the cushion 100 may also include a foam component or foam material in addition to a non-foam component to provide additional cushioning or localized cushioning for a seat occupant. For example, foam material may be provided between the cushion 100 and a trim cover (e.g., trim cover 34, 44) that is disposed on the cushion 100, within the cushion 100, or combinations thereof. Reducing the amount of foam material that is provided with the cushion 100 or eliminating foam material from the cushion 100 reduces weight and may improve support and comfort of a seat occupant. In addition, eliminating foam material may facilitate recycling of the cushion 100.

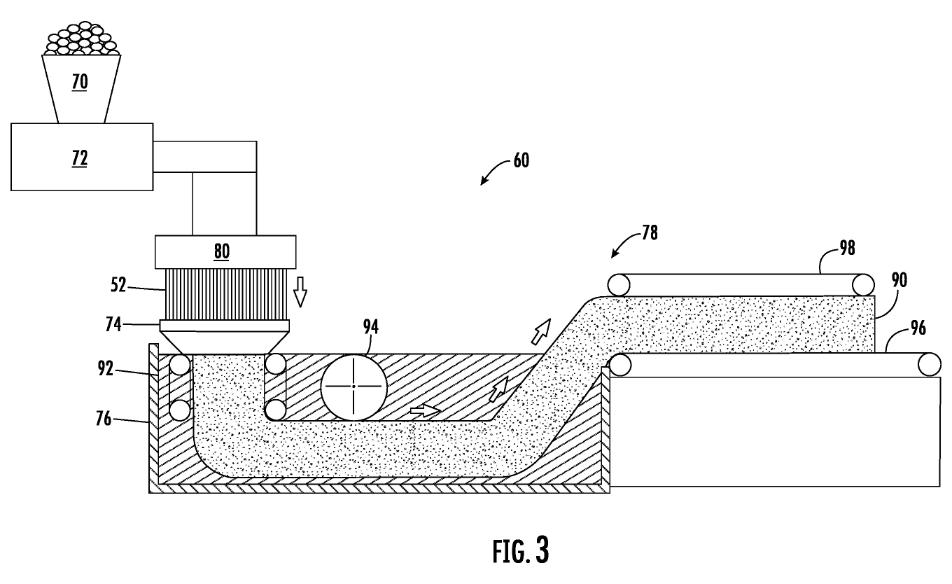

The cushion 100 is described below in the context of a cushion that does not include foam material. In one or more embodiments, the cushion 100 is made of filaments 52 of polymeric material that are randomly looped, bent, curled, or entangled and are bonded together, as shown, for example, in FIGS. 2 and 3. In a variation, one or more filaments 52 are directly bonded to one or more other filaments 52 rather than being indirectly bonded such as with a resin or other intermediate material.

In various embodiments, the filaments 52, which may also be referred to as strands or threads, are made of any suitable material or materials. In some configurations, the filaments 52 are made of a polymeric material (or molten polymeric material if appropriate for the particular application/invention) such as a thermoplastic material, polymer, and/or resin. For example, the polymeric material may be a polyamide, a polyester, a polyimide, a polyolefin (e.g., polypropylene, polyethylene, etc.), polystyrene, an acrylic, a polyurethane, derivatives thereof, combinations thereof or any other suitable polymeric material. As one example, a polyethylene-based filament may be made of linear low-density polyethylene (LLPDE). In one or more embodiments, the polymeric filament material such as a thermoplastic polymeric material may be recyclable unlike foam materials or may more easily be recycled compared with foam materials. In some embodiments, it is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. In one or more embodiments, it is contemplated that the cushion 100 may include a combination of monofilaments and filaments that are made of multiple materials and are not monofilaments. In various embodiments, filaments 52 that are randomly looped, bent, looped, curled, or entangled are bonded together where one filament 52 contacts, entangles, and/or is interlocked with another filament 52, thereby resulting in a lightweight, air permeable cushion (e.g., cushion 100) or mesh structure having openings or voids between the filaments 52.

Referring to FIG. 3, an example of a manufacturing system 60 to make a cushion or filament mesh structure is shown. In this example, the manufacturing system 60 includes a material supply 70, an extruder 72, and a funnel 74. In one or more embodiments, the manufacturing system 60 also includes a cooling tank 76 and a material handling subsystem 78. In various embodiments, the material supply 70 holds material stock that is to be extruded, such as solid beads, flakes, granules, pellets, or powder made of the material. In some configurations, the material supply 70 is configured as a container or hopper. In one or more embodiments, the material supply 70 provides material stock to the extruder 72.

In numerous embodiments, the extruder 72 melts the material stock and extrudes the material stock into a set of filaments 52. The extruder 72 may have any suitable configuration. In some configurations, the extruder 72 includes a barrel that receives a rotatable screw and heating elements. In one or more embodiments, rotation of the screw forces the material to move through the barrel and helps heat the material due to the friction generated as the screw rotates. In various embodiments, the material exits the barrel under pressure in a molten state and is transported under pressure to a die 80 of the extruder 72.

In one or more embodiments, the die 80, which may also be referred to as a die plate or extrusion die, has multiple through holes or filament forming openings through which the molten material passes. In various embodiments, a single filament 52 is extruded from each through hole. In a refinement, the filaments 52 are extruded through the die 80 such that the filaments 52 fall downward from the die 80 under the force of gravity into the funnel 74.

In various embodiments, the funnel 74 consolidates or groups the filaments 52 into a more compact arrangement in which the filaments bend, curl, or loop and/or one or more filaments 52 contact and bond to at least one other filament 52. In a refinement, the funnel 74 has an inlet opening or funnel inlet and an outlet opening or funnel outlet that is smaller than the funnel inlet such that individual separated filaments 52 enter the funnel inlet and the filaments 52 bend, curl, loop, and/or move into contact as they accumulate while moving through the funnel 74 toward the funnel outlet. In a variation, some filaments may slide along the funnel 74 or an intervening sheet that is disposed on the funnel 74 as the filaments move toward the funnel outlet. In various embodiments, bonds are formed between filaments 52 at the points of contact while openings or voids between filaments 52 are present at other locations where filament 52 or portions thereof do not contact or bond to another filament 52. In one or more embodiments, the entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively, or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

With the above process, the cushion 100 may be formed of a set of filaments 52, wherein at least two members of the set of filaments 52 are looped and/or bonded to each other. In one or more embodiments, each member of the set of filaments 52 is looped and/or bonded to at least one other member of the set of filaments.

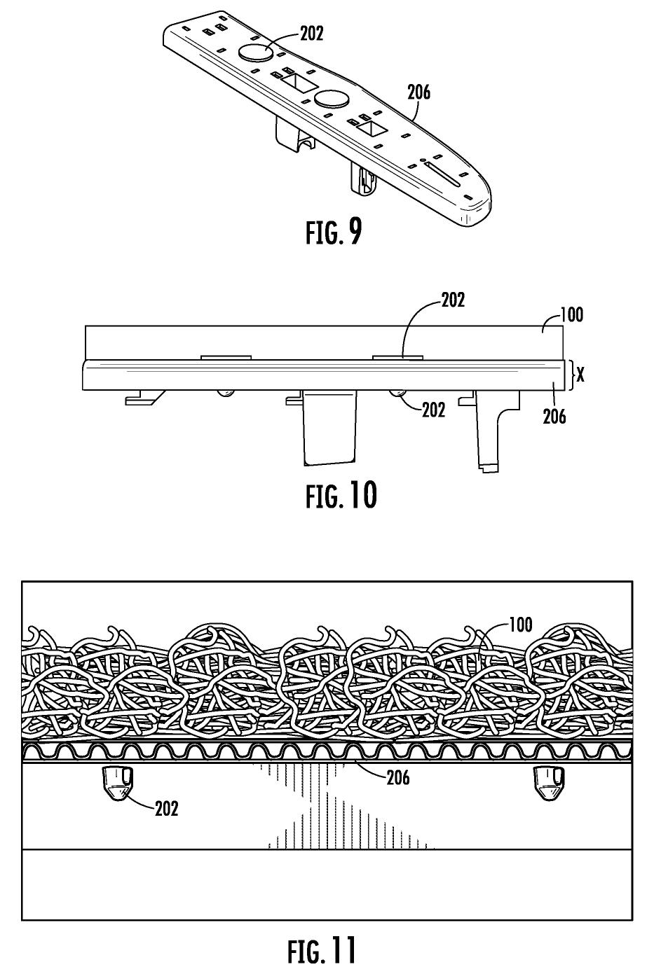

The structure of non-foam or foamless cushions may be difficult to secure with traditional fasteners designed to fasten, for example, foams. Accordingly, in one or more embodiments, the cushion assembly 200 includes one or more fasteners 202, as shown in FIGS. 2 and 4-11. In a refinement, the one or more fasteners 202 fasten one or more cushions 100 into position and/or couple the cushion 100 to a surface 204 such as another component 206 (e.g., arm rest). For example, the cushion assembly 200 includes a fastener 202 disposed in a cushion 100. In various embodiments, the fastener 202 may cooperate with a non-cushion component 206. In a refinement, the non-cushion component 206 is rigid such as a structural support or carrier board of a seat assembly 10 (e.g., arm rest support as shown in FIG. 9). For example, the non-cushion component 206 is a plastic such as polyethylene having a thickness (X as shown in FIG. 10) of at least 1 mm, or more preferably at least 3 mm, or even more preferably at least 5 mm, or still even more preferably at least 7 mm.

In one or more embodiments, the cushion 100 and non-cushion component 206 are arranged such that the cushion 100 is more adjacent the trim cover and/or a seated occupant. In various embodiments, the cushion 100 and non-cushion component 206 are configured to be arranged or is arranged such that the cushion 100 is disposed between a seated occupant/the trim cover and the rigid hard non-cushion component 206. In a variation, the non-cushion component 206 defines a shape or silhouette facing the seated occupant and the cushion 100 is defined as the same shape or silhouette.

In one or more embodiments, the fastener 202 and non-cushion component 206 cooperate through corresponding male and female components. In a refinement, the male and female components couple together and may or may not lock. For example, the fastener 202 includes a male portion and the non-cushion component 206 includes the female portion or vice versa. In other words, the fastener 202 includes a protruding portion 207 and the non-cushion component 206 includes an aperture/orifice 205 sized to receive the protruding portion 207 or vice versa.

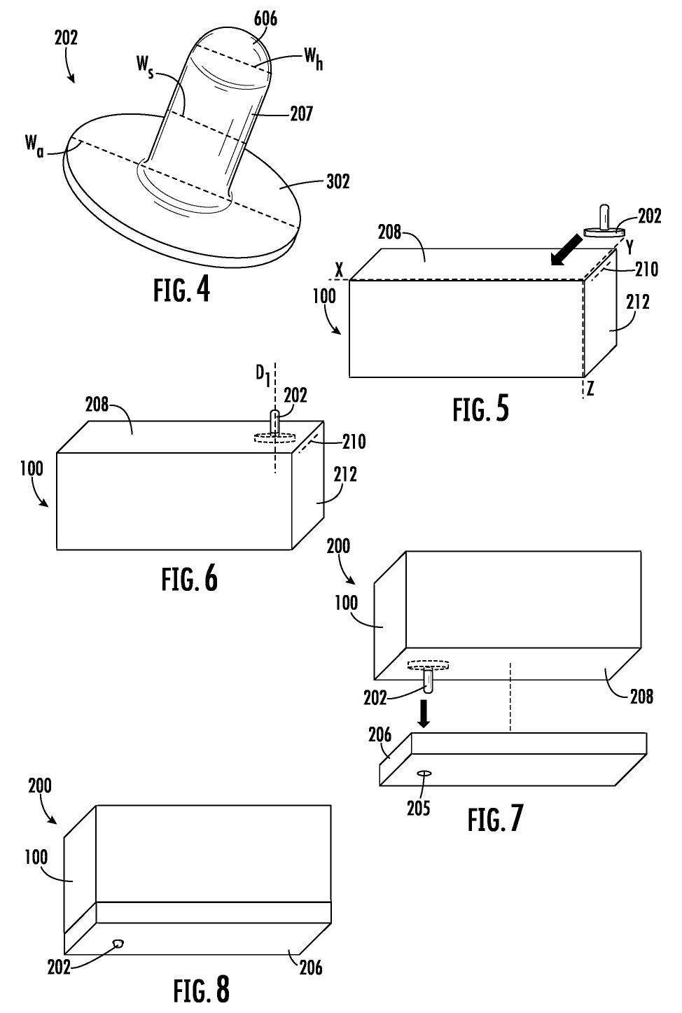

In various embodiments, as shown in FIG. 4, the fastener 202 has a retainer or anchor portion 302 that serves to retain or anchor the fastener 202 in the mesh member cushion (e.g., plurality of polymeric filaments). In a refinement, the fastener 202 also includes the protruding portion 207 extending from the retainer or anchor portion 302. In various embodiments, the protruding portion 207 is configured to be received by a non-cushion component 206 such as those depicted in FIGS. 2, 7-11. In a variation, the fastener 202 and non-cushion component 206 secure, lock, and/or fasten to one another such as through an interference fit. Additionally, or alternatively, the protruding portion 207 includes a fastening mechanism 306 such as a screw (i.e., spiral ramp), a clip (e.g., Christmas tree clip), a clasp, a hook, a rivet, a snap, or any other known fastening mechanisms (e.g., friction-based, keying, microbrazing, fusion, screw-action, rivets, adhesive, etc.) as shown in FIG. 2. For example, the protruding portion 207 is an elongated clip.

In various embodiments, as shown in FIGS. 5-8, the cushion 100 has a side defining a surface or surface portion 208 and a slot 210 below the surface or surface portion 208. For example, the cushion 100 includes a first side (e.g., top side) defining a first surface 208 (e.g., top surface) with a slot 210 below the first surface 208. In one or more embodiments, the slot 210 is defined in the cushion 100 from a second side/surface 212 such as the right or back side/surface of the cushion 100. For example, the slot 210 is cut into the cushion 100 from a different surface after extrusion and the fastener 202 is inserted into the cushion 100 via the slot 210. Alternatively, the slot 210 may be defined by a die during extrusion. In a refinement, the slot defines an entry port along the surface. The surfaces or surface portions described herein are relative to the cushion body formed by the polymeric filaments and not the individual polymeric filaments. For example, the cushion 100, as shown in FIG. 5, illustrates a first surface 208 corresponding to a first surface plane defined by the axes X and Y and the second surface corresponding to a second surface plane defined by the axes Y and Z. Although the cushions are depicted herein as rectangular or cuboidal, the shape and size of the cushions are not particularly limited in their shape or size and the surface is not limited to a plane.

In various embodiments, the fastener 202 is disposed in the slot 210 such that the retainer or anchor portion 302 is retained in the slot 210 while the protruding portion 207 extends through the filaments of the mesh member cushions 100 to cooperate with a non-cushion component 206, as shown in FIGS. 6-8. For example, the protruding portion 302 is received by an aperture/orifice 205 of the non-cushion component 206, as shown in FIG. 8. In a refinement, the protruding portion 302 engages the apertures/orifices via an interference fit to couple the cushion 100 to the non-cushion component 206. In one or more embodiments, the fastener 202 and non-cushion component 206 are coupled such that the first surface 208 and a surface of the non-cushion component 206 are adjacent one another.

As shown in FIGS. 2, 8, 10, and 11, the non-cushion component 206 is configured to receive the fastener 202. In various embodiments, the non-cushion component 206 includes an aperture/orifice 205 or a protruding portion for cooperating with the first fastener 202. In a variation, the non-cushion component 206 includes a fastening mechanism that corresponds with the fastening mechanism of the fastener 202. For example, the non-cushion component 206 defines a cavity, a hollow bin, an aperture/orifice configured to receive the protruding portion 207 of the fastener 202. For example, in some embodiments, the protruding portion 207 of the fastener 202 includes a screw (i.e., spiral ramp) and the non-cushion component 206 is configured to receive the screw. For example, a cavity/orifice of the non-cushion component 206 includes a groove corresponding to the screw for coupling the fasteners 202 to the non-cushion component 206. In yet another example, the fastening mechanism is a clip 306 (e.g., Christmas tree clip) and the cavity of the non-cushion component 206 includes one or more apertures (e.g., a plurality of aperture or at least two apertures) for receiving the clip 306.

In a refinement, the retainer or anchor portion 302 of the fastener 202 includes a plurality of barbs. In other words, any of the embodiments described herein may include a barbed retainer or anchor portion 302 to more securely retain or anchor the fastener 202 in the cushion 100. For example, the retainer or anchor portion 302 is configured to receive a portion of the non-cushion component 206 via an aperture/orifice and includes a plurality of barbs.

Again, referring to FIG. 4, the fastener 202 includes a retainer or anchor portion 302 and a protruding shaft portion 207 extending therefrom. In a variation, the fastener 202 also includes a head portion 606 disposed on the shaft portion 207 opposite the retainer or anchor portion 302. In a refinement, the head portion 606 is tapered, round, and/or pointed. In a refinement, the head portion 606 has a dimension Wₕ (e.g., width) that is substantially the same, the same, or smaller than the dimension Wₛ of the shaft portion. Alternatively, the head portion 606 has a greater or larger dimension Wₕ (e.g., width) than the dimension Wₛ of the shaft portion. In one or more embodiments, the head portion 606 is configured to inhibit the non-cushion component 206 from slipping or sliding off the shaft portion 207.

In one or more embodiments, the non-cushion component 206 is configured to cooperate with the shaft portion 207 such as by coupling (e.g., friction fit, snapping, and/or clipping) onto the shaft portion 207. For example, the fastener 202 is disposed in the cushion 100 such that the head portion 606 and shaft portion 207 are protruding through the cushion 100 into the non-cushion component 206. Upon protruding into the non-cushion component 206 an aperture/orifice 205 defined by the non-cushion component 206 is clipped onto the shaft portion 207 such that the cushion 100 is coupled to the non-cushion component 206.

In various embodiments, the fastener 202 described herein may be made of any suitable material. For example, the fastener 202 is or comprises a thermoplastic polymer (e.g., polyolefins, polyethylene, polypropylene, polystyrene, polycarbonate, and/or polyvinyl chloride). In a refinement, the fastener 202 is a low- or high-density polyethylene. In a variation, the fastener 202 is made of the same polymeric material as the mesh member cushion 100 and/or filaments 52 thereof such that they can be recycled with the cushion 100 and there is no need to remove them. In a refinement, the cushion 100 is coupled to the non-cushion component 206 without adhesive via the fastener 202. In other words, the cushion assembly 200 may be free or substantially free (i.e., less than 1%, 0.5%, or 0.1% by weight) of adhesive.

Referring again to FIG. 4, the shape of the retainer or anchor portion 302 is not particularly limited but in various embodiments includes a generally flat section that has a width Wₐ that is two, three, five, or ten times the width Wₛ of, for example, the protruding portion 207 and extends along the width of many polymeric filaments 52 such that the polymeric filaments 52 sterically inhibit the fastener 202 from moving along a first axis D₁, as shown in FIG. 6. For example, the retainer or anchor portion 302 is round, circular, rectangular, square-shaped, diamond-shaped, triangular, S-shaped, or any other suitable shape. The shape of the protruding portion 207 is not particularly limited. For example, the shape may be round, cylindrical, hooked shaped, or pointed. In a refinement, protruding portion 207 is a shape and width such that it more easily can be navigated through the plurality of polymeric filaments 52 of the mesh member cushion 100. For example, the protruding portion 207 includes a pointed or rounded tip to more easily penetrate through the filaments 52. In a variation, the protruding portion 207 is of a length such that it extends from the surface of the cushion 100, or more preferably extends from the slot 210 through the surface 208 of the cushion 100, or even more preferably from the slot 210, through the surface 208 of the cushion 100 and into the non-cushion component 206. In various embodiments, the retainer or anchor portion 302 has a larger cross-sectional area along the X-Y direction than the protruding shaft portion 207 and the head portion 606. In a refinement, the head portion 606 has a greater cross-sectional area than the protruding shaft portion.

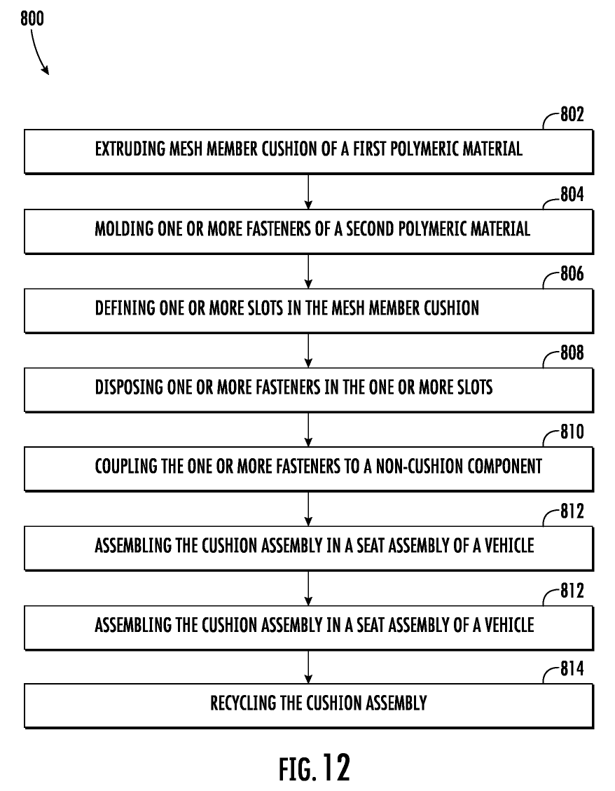

Referring to FIG. 12, a method 800 of producing a cushion assembly is disclosed. The method 800 includes one or more of the following steps: extruding one or more cushion bodies (i.e., step 802), molding one or more fasteners as described herein (i.e., step 804), defining one or more slots in the one or more cushion bodies (i.e., step 806), disposing one or more fasteners in the one or more slots (i.e., step 808), coupling the one or more fasteners to a non-cushion component (i.e., step 810), and assembling the cushion assembly into a seat assembly such as for a vehicle (i.e., step 812).

In various embodiments, the one or more cushion bodies are foamless or non-foam mesh member cushions comprising a plurality of entangled or intertwined polymeric filaments as described above. In a refinement, the slots may be cut into the cushions after extruding them. Alternatively, a breaker plate die may be used for that defines a cavity or slot in the cushion during extrusion. In one or more embodiments, the fasteners may be made from the same polymeric material as the cushions. Alternatively, the fasteners and cushions may be made from polymeric materials that can be recycled together without separation. For example, the cushions and fasteners are polymeric materials of different grades or polymeric materials having similar melting points.

In a variation, the fasteners are coupled into position or together by pressing them together to form a friction fit, screwing them together, by clipping them together, by snapping them together, or by any other suitable attachment mechanism. For example, a fastener having a retainer or anchor portion and a protruding portion is disposed in a cushion such as in a first slot of the first cushion by moving it laterally through the slot in a first direction until the fastener is in the desired or intended position (e.g., a predetermined position) and then extending or pushing the protruding portion through the cushion in a second direction that is different than the first direction until it extends or penetrates through a first surface of the cushion. For example, the first and second directions are perpendicular. In a refinement, the protruding portion is pushed until the protruding portion is received by and coupled to a non-cushion component such as a support structure (e.g., armrest).

Alternatively, a protruding portion of the non-cushion component may be pressed to penetrate through the mesh member cushion and coupled to a fastener disposed therein. In various embodiments, the fasteners may be adjustably fastened such as at predetermined increments to adjust the distance between the first retainer or anchor portion and the non-cushion component. For example, the fasteners may be fastened such that the cushion and non-cushion component are touching each other as in FIGS. 8 and 10-11. Alternatively, the fasteners may be fastened such that they define a gap.

In one or more embodiments, the cushion assembly or a portion thereof is recycled (i.e., step 814). As the cushion and one or more fasteners are made of compatible, similar, substantially similar, or the same material there is no need to separate or remove the fasteners before recycling. In a variation, recycling includes shearing the cushion assembly into smaller portions or pieces such as by grinding, smashing, tearing, shredding, and/or milling. In a refinement, the cushion assembly is melted into a polymeric resin such that it can be reused such as, for example, after a specific particle size is achieved or a specific period of shearing. In one or more embodiments, the polymeric resin is filtered, refined, or purified after melting and before reuse. In one or more embodiments, a plurality of cushion assemblies is recycled without removing the fasteners. In still other embodiments, one or more cushion assemblies may be produced from the recycled polymeric resin.

According to a first aspect of the cushion assemblies described herein, the assembly comprises a mesh member comprising a first side defining a first surface, the mesh member comprising a set of filaments of thermoplastic material, wherein each member of the set of filaments is looped and bonded to at least one other member of the set of filaments, a carrier board defining a second surface adjacent the first surface, and a fastener comprising a retainer portion disposed in the mesh member and a protruding portion protruding from the retainer portion through the first surface of the mesh member and through the second surface of the carrier board such that the protruding portion cooperates with the carrier board to secure the mesh member adjacent the carrier board.

According to a second aspect, the carrier board of the first aspect or any of the subsequent aspects is an armrest.

According to a third aspect, the carrier board of any of the prior or subsequent aspects has a thickness of at least 3 mm.

According to a fourth aspect, the carrier board of any of the prior or subsequent aspects has a thickness of at least 5 mm.

According to a fifth aspect, the carrier board of any of the prior or subsequent aspects defines an aperture sized to receive the fastener.

According to a sixth aspect, the fastener of any of the prior or subsequent aspects cooperates with the carrier board via an interference fit in the aperture.

According to a seventh aspect, the mesh member of any of the prior or subsequent aspects arranged to be more proximate a trim cover than the carrier board.

According to an eighth aspect, the carrier board of any of the prior or subsequent aspects defines a silhouette shape and the mesh member defines the same silhouette shape.

According to a nineth aspect, the retainer portion of any of the prior or subsequent aspects is disposed in a slot defined by the mesh member.

According to a tenth aspect, the slot of any of the prior or subsequent aspects comprises an entry port and the entry port is disposed on a second surface of the mesh member that is different than the first surface.

According to an eleventh aspect, the retainer portion of any of the prior or subsequent aspects comprises a greater cross-sectional area than the protruding portion.

According to a twelfth aspect, the fastener of any of the prior or subsequent aspects is made of a thermoplastic polymer material.

According to a thirteenth aspect, the fastener of any of the prior or subsequent aspects is made of a thermoplastic polymer material and the set of filaments is made of the same thermoplastic polymer material.

According to a fourteenth aspect, a seat assembly of a vehicle comprises the assembly of any of the prior or subsequent aspects mounted on a frame.

According to a fifteenth aspect, a fastener assembly comprises a retainer portion to be disposed in a cushion body and a protruding portion protruding from the retainer portion, the protruding portion shaped and sized to extend from a slot in the cushion body through a first side of the cushion body to engage a support board such that the protruding portion is secured to the support board and the retainer portion is retained in the cushion body to secure the cushion body to the support board.

According to a sixteenth aspect, a method comprises disposing a fastener comprising a retainer portion in a slot defined by a cushion, the first slot being disposed below a surface portion along a first side of the cushion; and coupling the fasteners to a rigid support such that the protruding portion extends through the cushion and the surface portion into the rigid support.

According to a seventeenth aspect, the method of the prior aspect or any of the subsequent aspects further comprises molding the fastener and the cushion from a polymer that is the same.

According to an eighteenth aspect, the method of any of the prior or subsequent aspects further comprises recycling the cushion and the fastener.

According to a nineteenth aspect, the method of any of the prior or subsequent aspects wherein recycling comprises shearing the cushion and fastener into smaller pieces and melting the smaller pieces to form a polymer resin.

According to a twentieth aspect, the method of any of the prior aspects further comprising defining the first slot from a second side of the cushion that is different than the first side.

While exemplary embodiments are described above, it is not intended that these embodiments describe all possible forms encompassed by the claims. The words used in the specification are words of description rather than limitation, and it is understood that various changes can be made without departing from the scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An assembly comprising:
a mesh member comprising a first side defining a first surface, the mesh member comprising a set of filaments of thermoplastic material, wherein each member of the set of filaments is looped and bonded to at least one other member of the set of filaments;
a carrier board defining a second surface adjacent the first surface; and
a fastener comprising a retainer portion disposed in the mesh member and a protruding portion protruding from the retainer portion through the first surface of the mesh member and through the second surface of the carrier board such that the protruding portion cooperates with the carrier board to secure the mesh member adjacent the carrier board.

2. The assembly of claim 1, wherein the carrier board is an armrest.

3. The assembly of claim 1, wherein the carrier board comprises a thickness of at least 3 mm.

4. The assembly of claim 1, wherein the carrier board comprises a thickness of at least 5 mm.

5. The assembly of claim 1, wherein the carrier board defines an aperture sized to receive the fastener.

6. The assembly of claim 5, wherein the fastener cooperates with carrier board via an interference fit in the aperture.

7. The assembly of claim 1, wherein the mesh member is arranged to be more proximate a trim cover than the carrier board.

8. The assembly of claim 1, wherein the carrier board defines a silhouette shape and the mesh member defines the same silhouette shape.

9. The assembly of claim 1, wherein the retainer portion is disposed in a slot defined by the mesh member.

10. The assembly of claim 9, wherein the slot comprises an entry port and the entry port is disposed on a second surface of the mesh member that is different than the first surface.

11. The assembly of claim 1, wherein the retainer portion comprises a greater cross-sectional area than the protruding portion.

12. The assembly of claim 1, wherein the fastener is made of a thermoplastic polymer material.

13. The assembly of claim 1, wherein the fastener is made of a thermoplastic polymer material and the set of filaments is made of the same thermoplastic polymer material.

14. A seat assembly of a vehicle comprising the assembly of claim 1, mounted on a frame.

15. A fastener assembly comprising:
a retainer portion to be disposed in a cushion body and a protruding portion protruding from the retainer portion, the protruding portion shaped and sized to extend from a slot in the cushion body through a first side of the cushion body to engage a support board such that the protruding portion is secured to the support board and the retainer portion is retained in the cushion body to secure the cushion body to the support board.

16. A method comprising:
disposing a fastener comprising a retainer portion in a slot defined by a cushion, the first slot being disposed below a surface portion along a first side of the cushion; and
coupling the fasteners to a rigid support such that the protruding portion extends through the cushion and the surface portion into the rigid support.

17. The method of claim 16, further comprising molding the fastener and the cushion from a polymer that is the same.

18. The method of claim 17, further comprising recycling the cushion and the fastener.

19. The method of claim 18, wherein recycling comprises shearing the cushion and fastener into smaller pieces and melting the smaller pieces to form a polymer resin.

20. The method of claim 16, further comprising defining the first slot from a second side of the cushion that is different than the first side.
